(19) United States
(12) Patent Application Publication
(10) Pub. No.: US 2002/0016760 A1
(43) Pub. Date: Feb. 7, 2002

(54) Efficient mechanism for trading multiple dissimilar products

(76) Inventor: Sanjesh Pathak, Houston, TX (US)

Correspondence Address: Sanjesh Pathak, 2500 Old Farm # 431, Houston, TX, 77063, US

(21) Appl. No.: 09/901,021

(22) Filed: Jul. 10, 2001

Related U.S. Application Data
(60) Provisional application No. 60/216,711, filed on Jul. 7, 2000.

(51) Int. Cl. G06F 17/60

(52) U.S. Cl. 705/37; 705/26

(57) ABSTRACT

The present invention provides an efficient method for trading multiple dissimilar products. A method and apparatus for implementing a mechanism by which a combination of products may be exchanged among market participants. The market participants use an online/computerized auction/bidding system to trade their products. For businesses trying to dispose products, this type of mechanism will result in higher revenue for the seller and at the same time satisfies the buyer. For businesses trying to acquire products, this type of mechanism will result in lowering the cost of procuring products and at the same time satisfies sellers.

### CLAIM OF PRIORITY

This application claims priority under 35 U.S.C 119 (e) (1) from U.S. Provisional Patent Application No. 60/216,711, filed Jul. 7, 2000.

### CROSS-REFERENCE TO RELATED APPLICATIONS

1. Godin Paul B., Lymbumer Jeffery “Computer auction system”, U.S. Pat. No. 5,890,138.

2. Ausubel Lawrence M., “Computer implemented methods and apparatus for auctions”, U.S. Pat. No. 5,905,975

3. Hamdya A. Taha, Operations Research—An Introduction, Third Edition, Macmillan Publishing Co., Inc., New York.

4. A Comparative Study of Optimization Techniques, Optimization Technology—White paper, ILOG, Inc. Mountain View, Calif.

### STATEMENT REGARDING FEDERALLY SPONSORED RESEARCH OR DEVELOPMENT

Not applicable

### REFERENCE TO A MICROFICHE APPENDIX

Not applicable

### FIELD OF THE INVENTION

The present invention relates to online/computerized auction/bidding system and a method for carrying out an auction/bidding system where users access the auction/bidding system by remote computers through a computer network. Currently auctions/bidding systems provide participants to dispose or acquire only one particular type of product. The present invention provides a method and apparatus to dispose or acquire multiple dissimilar products.

### BACKGROUND OF THE INVENTION

Auctions/bidding for sale of products, goods or services have proven to be very popular. Typically with auction/bidding systems, there is a possibility to obtain the product at a very competitive price. The standard ascending auction process involves users bidding for a particular product, and the product is sold to the highest bidder. The aim here is for the seller of the product to sell at the maximum price. A product here in the present context means any product or goods or assets or service.

There is a variation of auction/bidding called the reverse auction. In this type of auction, a buyer posts his wish to buy or procure product or goods or services (this could be a Tender or Request for Proposal (RFP) or Request for Quote (RFQ) or any other term used for buying or procuring products). The sellers or providers of the products or goods or services then bid for it. In this type of auction/bidding the price of the bid generally decreases during the time period of the auction/bidding process. The aim of the buyer here is to buy or procure products at the lowest price.

There are also different types of auction/bidding systems: i) Open-bid and ii) Sealed-bid

i) Sealed-bid auction: In the standard sealed-bid auction, bidders—in one single bidding round—simultaneously and independently submit bids to the auctioneer, who then determines the auction outcome. The bids received are not shown to the other bidders. This type of auction/bidding processes does not provide any real time feedback. Buyers merely submit their bid, which is confidential.

ii) Open-bid auction: In an open-bid auction, bidders submit bids in real time until no more bids are forthcoming or a time is elapsed. An open-bid format offers the advantage that there is feedback between participants' bids: each bidder is able to infer other bidders' information about the value of the object(s) as the auction progresses and incorporate this information into his subsequent bids. This feedback tends to result in more efficient auction outcomes as well as more aggressive bidding, resulting in higher expected revenues for the seller in forward auction and a lowering of cost for the buyer in reverse auction. In open-bid, there is the excitement as the bids are displayed in real time and the participants can view the results in real-time.

There is another variation of the auction/bidding process where the seller or buyer specifies a reserve price. In the case of forward auction, the seller is going to sell the product only if the bid amount is greater than or equal to the reserve price otherwise the seller does not to sell the product. In the case of reverse auction, the buyer wants to buy the product only if the bid amount of the seller is less than or equal to the reserve price otherwise the buyer does not want to buy the product.

Most of the auctions/bidding systems provide participants to dispose or acquire only one particular type of product. The present invention provides a method and apparatus to dispose or acquire multiple dissimilar products.

### BRIEF SUMMARY OF THE INVENTION

The present invention relates to trading of products in bundles. Traditionally trading occurs between two businesses on a product-by-product basis. A business may want to acquire or dispose (sell) a particular product or a portfolio of products. In either case, individual transactions are consummated with respect to each of the products individually. However, in many situations, a market participant does not necessarily derive value for a single product, but for a basket of products. In such a circumstance, the acquisition or disposition of products on a product-by-product basis in order to obtain the basket of products in the right proportion, and at the right price, may prove to be mathematically complicated and time consuming task.

The market participant's problem is further exacerbated when the products are within different product classes. Here and throughout, the term product is used in its broadest sense. A product may be anything of value, and in a particular context, may be a commodity or other good, securities, or services, as well as money. In a similar vein, a business can mean any individual or a business or any entity that is trying to acquire or dispose products.

To illustrate the problem, consider a scenario where a business is trying to sell off excess inventory. The inventory might contain different product classes in different quantities. The business (seller in this case) wants to sell off this whole inventory. Traditionally, the business will opt for one of the two ways:

i) Seller will ask for bidders to submit bid for the whole lot. Seller will then select the highest bidder and sell the whole inventory to this highest bidder.

Or

ii) The seller will seek bids for each particular product class individually. The seller will then pick highest bids for each of these different product classes and sell them accordingly.

In either case, the market mechanism is not efficient.

Consider case i). Selling the whole lot as one piece might eliminate lot of buyers who might not have the resources to bid for the whole lot. Also, some buyers may be interested in buying some of the products and not the rest of the products, so they do not want to bid for the whole lot. But the bidder/buyer has no choice of choosing different products in this case.

Consider case ii). Selling the products individually may lead to potential loss for the seller as well as the buyer. Some buyers might need a group or a combination of products. To the buyer, this combination of products as a whole might be worth more than the worth of each of these individual products. Since in this case, there is no guarantee that the buyer will get all the products the buyer bid for (since the seller will pick highest bids for each of these individual products), the buyer is not guaranteed to get the combination of products that he bid. This might discourage those buyers to not place the bids, as the buyer is not guaranteed to get all the products that have been bid for. The buyer might get some products and not all the products the buyer bid. The buyer might be interested in all or none and so might end up with some products that might not be worth much to him.

In both the cases, this type of disposal of products eliminates those businesses that want to bid for a combination of different kinds of products. In both the cases, the seller and the buyer are at a disadvantage. For seller, the number of buyer pool is reduced thus limiting the bids. For buyers, the disadvantage is that the buyer has a limited choice.

The same analogy can be applied for businesses trying to acquire products. Generally businesses acquire products through Request for Proposal (RFP) or Request for Quotes (RFQ) or tenders. Regardless of the method used a method and apparatus is required which will let providers or sellers of the products to submit bids for a combination of products. This type of mechanism will result in a lower cost of acquiring products for the buyers and at the same time benefits seller as the seller can pick and choose the combination of products the seller wants to bid for.

Thus, there is a need in the art for a method and apparatus for implementing a mechanism by which a combination of products may be exchanged among market participants. For businesses trying to dispose products, this type of mechanism will result in higher revenue for the seller and at the same time satisfies the buyer. For businesses trying to acquire products, this type of mechanism will result in lowering the cost of procuring products and at the same time satisfies sellers.

### BRIEF DESCRIPTION OF THE DRAWINGS

Preferred embodiments of the invention are shown in the drawings, wherein:

FIG. 1 shows an overview of the system.

FIG. 2 shows the logical flow process of the optimization program

### DETAILED DESCRIPTION OF THE INVENTION

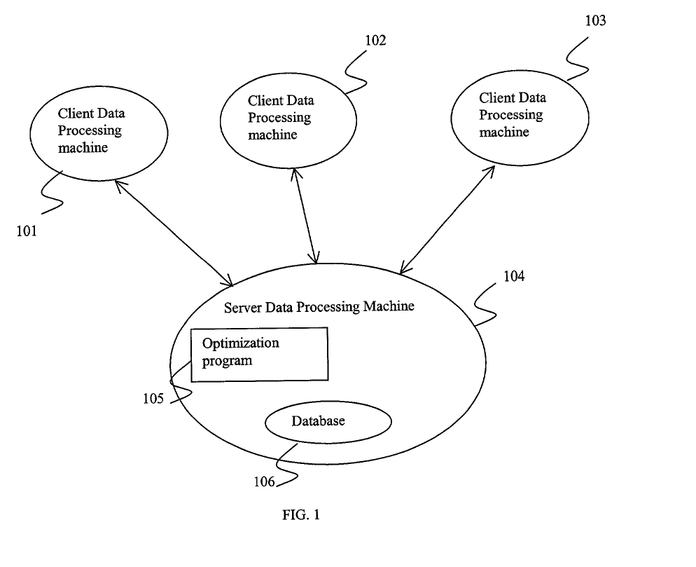

FIG. 1 illustrates an overview of the system. With this system a hosts of users (buyers or sellers) access the server data processing system 104 through the client data processing system 101, 102, 103 etc. Although only three client data processing systems are shown connected to the server processing machine in FIG. 1, the server data processing machine can host many client data processing systems. The client data processing systems connect to server data processing system though networks.

The users enter their data through client processing machines 101, 102, 103 etc. The users submit the data to server processing system 104. The server processing system 104 then stores the data into the database 106.

In case of sellers selling items, the seller enters the items to be sold, the time the bidding process expires and any other information like shipping and handling costs, tax or any other cost associated with the trade. Buyers access the server data processing machine 104 and bid for the items. Once the bid is submitted, the server processing machine 104 communicates the information to the optimization program 105. The optimization program 105 then gathers all the data relevant to the data and starts processing to find the winning bids. The optimization program 105 updates the result into the database 106.

In case of buyers procuring items, the buyer enters the items to be sold, the time the bidding process expires and any other information like shipping and handling costs, tax or any other cost associated with the trade. Sellers access the server data processing system 104 and bid for the items. Once the bid is submitted, the server processing system 104 communicates the information to the optimization program 105. The optimization program 105 then gathers all the data relevant to the data and starts processing to find the winning bids. The software program updates the result into the database 106.

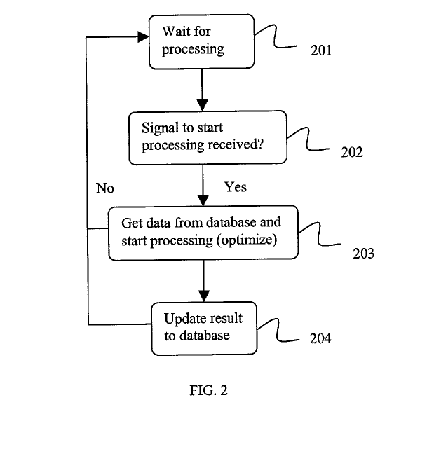

FIG. 2 shows the logical flow process of the optimization program 105 of FIG. 1. The program waits for the signal to start 201. Once the signal is received 202, it gets the relevant data from the database and starts to process or optimize the data 203 and calculates the winning bids. The results are then updated into the database 204.

### EXAMPLE 1

For example, assume that a business wants to sell off excess inventory. The inventory consists of m items. Item 1 in Q₁ quantity, Item 2 in Q₂ quantity and Item 3 in Q₃ . . . Item m in Qₘ quantity. The business is now asking for bids from potential buyers. This bid could be of any form like open-bid auction, sealed bid auction, dynamic bidding where market participants can update their bids real-time. Regardless of the type used, the seller is trying to maximize his revenue by selling the inventory. Once the bids are received, the seller has to decide which bids to accept. Assume the seller receives following bids:

Bid B₁ offering an amount of P₁ for items: Item 1 in Q₁¹ quantity, Item 2 in Q₂¹ quantity . . . Item m in Qₘ¹ quantity.

•

•

Bid Bₙ offering an amount of Pₙ for items: Item 1 in Q₁ⁿ quantity, Item 2 in Q₂ⁿ quantity . . . Item m in Qₘⁿ quantity.

It should be noted that quantity bid for each individual item i can be anything from zero (0) to quantity (Qᵢ) available for sale for that item. The seller wants to select bids that result in maximum revenue. This involves solving the following problem for:

Maximize: P₁*Y₁+P₂*Y₂+ . . . Pₙ*Yₙ

Within Constraints:

Q₁¹+Q₁²+Q₁³+ . . . +Q₁ⁿ<=Q₁

Q₂¹+Q₂²+Q₂³+ . . . +Q₂ⁿ<=Q₂

•

•

Qₘ¹+Qₘ²+Qₘ³+ . . . +Qₘⁿ<=Qₘ

Y₁ either 0 or 1

Y₂ either 0 or 1

•

•

Yₙ either 0 or 1

The above problem can be solved using any one of the optimization techniques like: linear programming, integer programming, domain reduction and constraint propagation, combinatorial optimization, genetic algorithms, simulated annealing or any other way for solving the problem that might be available. When for any n, if Yn is 1, it means the seller will select the bid n and Yn is zero (0) signifies that the bid n is not selected.

### EXAMPLE 2

A similar scenario can be applied to business trying to acquire assets. Assume that a business wants to acquire or buy Item 1 in Q₁ quantity, Item 2 in Q₂ quantity and Item 3 in Q₃ . . . Item m in Qₘ quantity. The buyer then asks for bids from potential sellers. The process of getting bids could be in any form like RFP, RFQ or tenders, it could be either offline or online, dynamic bidding where seller see all bids in real-time or could be a sealed bid or open-bid. Assume that the buyer has received following bids from seller:

Bid B₁ offering to sell at price of P₁ for items: Item 1 in Q₁¹ quantity, Item 2 in Q₂¹ quantity. Item m in Qₘ¹ quantity.

•

•

Bid Bₙ offering to sell at price of Pₙ for items: Item 1 in Q₁ⁿ quantity, Item 2 in Q₂ⁿ quantity . . . Item m in Qₘⁿ quantity.

It should be noted that quantity bid for each individual item i can be anything from zero (0) to quantity (Qᵢ) available for sale for that item. The buyer wants to select bids that result in minimum cost. This involves solving the following problem:

Minimize: P₁*Y₁+P₂*Y₂+ . . . Pₙ*Yₙ

Within Constraints:

Q₁¹+Q₁²+Q₁³+ . . . +Q₁ⁿ>=Q₁

Q₂¹+Q₂²+Q₂³+ . . . +Q₂ⁿ>=Q₂

•

•

Qₘ¹+Qₘ²+Qₘ³+ . . . +Qₘⁿ>=Qₘ

Y₁ either 0 or 1

Y₂ either 0 or 1

•

•

Yn either 0 or 1

Similarly, the above problem can be solved using any one of the optimization techniques like: linear programming, integer programming, domain reduction and constraint propagation, combinatorial optimization, genetic algorithms, simulated annealing or any other way for solving the problem that might be available. When for any n, if Yn is 1, it means the seller will select the bid n and Yn is zero (0) signifies that the bid n is not selected.

A variation to Example 2. involves solving the above problem:

Minimize: P₁*Y₁+P₂*Y₂+ . . . Pₙ*Yₙ

Within Constraints:

Q₁¹+Q₁²+Q₁³+ . . . +Q₁ⁿ=Q₁

Q₂¹+Q₂³+ . . . +Q₂ⁿ=Q₂

•

•

Qₘ¹+Qₘ²+Qₘ³+ . . . +Qₘⁿ=Qₘ

Y₁ either 0 or 1

Y₂ either 0 or 1

•

•

Yₙ either 0 or 1

In this case, the buyer wants to procure products only when he can get them in the exact quantity.

A further variation to the auction/bidding system can be accomplished by having a reserve price for the whole lot or items. That is, in the case of seller selling items, the winning bids will be chosen only when the sum of the bid amount of the winning bids is greater than or equal to the reserve price else no winning bids will be chosen. Similarly, in the case of buyer trying to procure items, the winning bids will be chosen only when the sum of the bid amount of the winning bids is less than or equal to the reserve price, else no winning bids will be chosen.

I claim:

1. A method for sellers and buyers to trade multiple dissimilar products.

2. A method as claimed in 1 is set up of data processing machine site for facilitating trade of multiple dissimilar products comprising at least one server data processing machine designed for serving a host of client data processing machines and provide said server data processing machines with the capability to participate in various trades where the trading is of a multiple dissimilar products at a specified time with a specified number of the multiple dissimilar products available for trade;
the said server data processing machine cooperating with database data processing machine to store the data
sellers, buyers and users of the system access the server data processing machine through the client data processing machine and trade their products
an optimization program resides in the server data processing machine to process the data and calculate winning bids

3. A method for sellers to sell multiple dissimilar products comprising steps of:
a. setting up a system as recited in claim 2
b. sellers set up their items for sale accessing the server data processing machine through client data processing machine
c. seller enters the items that he/she wishes to sell, the time the bidding process expires and the type of auction
d. the seller specifies additional information such as but not limited to shipping and handling, tax etc. or any other cost related to the trade
e. seller specifies the type of bidding process as an open-bid or a sealed-bid process
f. buyers or bidders bid for products by accessing server data processing machine through the client data processing machines comprising steps of:
i. buyers pick and choose individual items or a group of items they wish to buy and bid for the items
ii. buyers picking any combination of items in any quantity: the quantity chosen by bidder j satisfies the following equation:
0<=Qᵢ^{j}<=Qᵢ.
Where
Qᵢ^{j} is quantity of item i chosen by bidder j
Qᵢ is the quantity of item i put for sale by seller
iii. the server data processing machine accepts the bids from buyers and stores them in the database
iv. the optimization program residing in the server data processing machine processes the bids and calculates the winning bids based on the bid amount and additional information provided by seller as recited in claim 3.d to find the winning bids
v. the winning bids claimed in 3.f. iv are calculated such that the seller gets the maximum revenue
vi. the optimization program as claimed in 3.f.iv solves the following problem:
Maximize:
P₁*Y₁+P₂*Y₂+ . . . Pₙ*Yₙ
Within constraints:
Q₁¹+Q₁²+Q₁³+ . . . +Q₁ⁿ<=Q₁
Q₂¹+Q₂²+Q₂³+ . . . +Q₂ⁿ<=Q₂
•
•
Qₘ¹+Qₘ²+Qₘ³+ . . . +Qₘⁿ<=Qₘ
Y₁ either 0 or 1
Y₂ either 0 or 1
•
•
Yₙ either 0 or 1
Where
Q₁ is the quantity of item i in the lot
m is the number of different products classes in the lot
n is the number of bids
Pⱼ is the profit to the seller if bidder j is one of the winning bids. Pⱼ is the equal to the bid amount of bidder j minus any associated cost that will be borne by the seller by choosing bidder j as the winning bid
Qₘⁿ is the quantity of item m chosen by buyer n
vii. the method in claim 3.fvi uses any of the following optimization techniques for optimization: linear programming, integer programming, domain reduction and constraint propagation, combinatorial optimization, genetic algorithms, simulated annealing or any other way for solving the problem that might be available
viii. the optimization program claimed in 3.f.vi solves for values of Yᵢ, i=1 to n
ix. if Yₙ is 1, then bid n is one of the winning bids.
x. step 3.f.iv is executed whenever a new bid is submitted as claimed in 3.f.i.
xi. steps 3.fi to 3.f.iv go on till the time the bidding process ends at the time specified in 3.c
xii. After the expiration of time specified in 3.c, the bidding process ends and the winners are declared based on the last process run by step 3.f.iv
xiii. if the bidding process is an open-bid process, then winning bids are displayed continuously to the buyers during the bidding process else if the process is a sealed-bid process, then the winning bids are not displayed to the buyers until after the bidding ends and winner are declared

4. A method for sellers to sell multiple dissimilar products comprising steps of:
a. setting up a system as recited in claim 2
b. sellers set up their items for sale accessing the server data processing machine through client data processing machine
c. seller enters the items that he/she wishes to sell, the time the bidding process expires and the type of auction
d. the seller specifies a reserve price (R) for the whole lot
e. the seller specifies additional information such as but not limited to shipping and handling, tax etc. or any other cost related to the trade
f. seller specifies the type of bidding process as an open-bid or a sealed-bid process
g. buyers or bidders bid for products by accessing server data processing machine through the client data processing machines comprising steps of:
i. buyers pick and choose individual items or a group of items they wish to buy and bid for the items
ii. buyers picking any combination of items in any quantity: the quantity chosen by bidder j satisfies the following equation:
0<=Qᵢ^{j}<=Qᵢ.
Where
Qᵢ^{j} is quantity of item i chosen by bidder j
Qᵢ is the quantity of item i put for sale by bidder
iii. the server data processing machine accepts the bids from buyers and stores them in the database
iv. the optimization program residing in the server data processing machine processes the bids and calculates the winning bids based on the bid amount and additional information provided by seller as recited in claim 4.e to find the winning bids
v. the winning bids claimed in 4.g.iv are calculated such that the seller gets the maximum revenue
vi. the optimization program as claimed in 4.g.iv solves the following problem:
Maximize:
P₁*Y₁+P₂*Y₂+ . . . Pₙ*Yₙ
Within constraints:
Q₁¹+Q₁²+Q₁³+ . . . +Q₁ⁿ<=Q₁
Q₂¹+Q₂²+Q₂³+ . . . +Q₂ⁿ<=Q₂
•
•
Qₘ¹+Qₘ²+Qₘ³+ . . . +Qₘⁿ<=Qₘ
Y₁ either 0 or 1
Y₂ either 0 or 1
•
•
Yₙ either 0 or 1
Where
Qᵢ is the quantity of item i in the lot
m is the number of different products classes in the lot
n is the number of bids
Pⱼ is the profit to the seller if bidder j is one of the winning bids. Pⱼ is the equal to the bid amount of bidder j minus any associated cost that will be borne by the seller by choosing bidder j as the winning bid
Qₘⁿ is the quantity of item m chosen by buyer n
vii. the method in 4.g.vi uses any of the following optimization techniques for optmization: linear programming, integer programming, domain reduction and constraint propagation, combinatorial optimization, genetic algorithms, simulated annealing or any other way for solving the problem that might be available
viii. the optimization program claimed in 4.g.vi solves for values of Yᵢ, i=1 to n
ix. if Σ Pᵢ*Yᵢ for i=1 to n is greater than or equal to reserve price (R) of claim 4.d, and if Yₙ is 1, then bid n is one of the winning bids.
x. step 4.g.iv is executed whenever a new bid is submitted
xi. steps 4.g.i to 4.g.iv go on till the time the bidding process ends at the time specified in claim 4.c
xii. After the expiration of time specified in 4.c, the bidding process ends and the winners are declared based on the last process run by step 4.g.iv
xiii. if the bidding process is an open-bid process, then winning bids are displayed continuously to the buyers during the bidding process else if the process is a sealed-bid process, then the winning bids are not displayed to the buyers until after the bidding ends and winner are declared

5. A method for sellers to sell multiple dissimilar products comprising steps of:
a. setting up a system as recited in claim 2
b. sellers set up their items for sale accessing the server data processing machine through client data processing machine
c. seller enters the items that he/she wishes to sell, the time the bidding process expires and the type of auction
d. seller specifies a reserve price Rᵢ for each unit of the item i in the lot. The seller will accept bid from a bidder only if bid amount Bⱼ of bidder j is greater than or equal to Σ Rᵢ*Qᵢ^{j}, i=1 to m, where Qᵢ^{j} is the quantity of item i chosen for bidding by bidder j and m is the number of dissimilar items in the lot.
e. the seller specifies additional information such as but not limited to shipping and handling, tax etc. or any other cost related to the trade
f. seller specifies the type of bidding process as an open-bid or a sealed-bid process
g. buyers or bidders bid for products by accessing server data processing machine through the client data processing machines comprising steps of:
i. buyers pick and choose individual items or a group of items they wish to buy and bid for the items
ii. buyers picking any combination of items in any quantity: the quantity chosen by bidder j satisfies the following equation:
0<=Qᵢ^{j}<=Qᵢ.
Where
Qᵢ^{j} is quantity of item i chosen by bidder j
Qᵢ is the quantity of item i put for sale by bidder
iii. the server data processing machine accepts the bids from buyers and stores them in the database
iv. the optimization program residing in the server data processing machine processes the bids and calculates the winning bids based on the bid amount and additional information provided by seller as recited in claim 5.e to find the winning bids
v. the winning bids claimed in 5.g.iv are calculated such that the seller gets the maximum revenue
vi. the optimization program as claimed in 5.g.iv solves the following problem:
Maximize:
P₁*Y₁+P₂*Y₂+ . . . Pₙ* Yₙ
Within constraints:
Q₁¹+Q₁²+Q₁³+ . . . +Q₁ⁿ<=Q₁
Q₂¹+Q₂²+Q₂³+ . . . +Q₂ⁿ<=Q₂
•
•
Qₘ¹+Qₘ²+Qₘ³+ . . . +Qₘⁿ<=Qₘ
Y₁ either 0 or 1
Y₂ either 0 or 1
•
•
Yₙ either 0 or 1
Where
Qᵢ is the quantity of item i in the lot
m is the number of different products classes in the lot
n is the number of bids
Pⱼ is the profit to the seller if bidder j is one of the winning bids. Pⱼ is the equal to the bid amount of bidder j minus any associated cost that will be borne by the seller by choosing bidder j as the winning bid
Qₘⁿ is the quantity of item m chosen by buyer n
vii. the method in 5.g.vi uses any of the following optimization techniques for optmization: linear programming, integer programming, domain reduction and constraint propagation, combinatorial optimization, genetic algorithms, simulated annealing or any other way for solving the problem that might be available
viii. the optimization program claimed in 5.g.vi solves for values of Yᵢ, i=1 to n
ix. if Yₙ is 1, then bid n is one of the winning bids.
x. step 5.g.iv is executed whenever a new bid is submitted
xi. steps 5.g.i to 5.g.iv go on till the time the bidding process ends at the time specified in 5.c
xii. After the expiration of time specified in 5.c, the bidding process ends and the winners are declared based on the last process run by step 5.g.iv
xiii. if the bidding process is an open-bid process, then winning bids are displayed continuously to the buyers during the bidding process else if the process is a sealed-bid process, then the winning bids are not displayed to the buyers until after the bidding ends and winner are declared

6. A method for buyers to buy multiple dissimilar products comprising steps of:
a. setting up a system as recited in claim 2
b. buyers set up items they wish to procure by accessing the server data processing machine from a client data processing machine through a computer network
c. buyer enters the items that he/she wishes to buy and enters the time the bidding process expires and type of auction
d. buyer specifies additional information such as but not limited to shipping and handling, tax etc. or any other cost associated with the trade
e. buyer specifies whether it is an open-bid or a sealed-bid process
f. sellers bid for the items by accessing server data processing machine through the client data processing machines comprising steps of:
i. sellers pick and choose individual items or a group of items they wish to sell and bid for the items
ii. sellers pick any combination of items in any quantity—quantity chosen by seller j satisfies the following equation:
0<=Qᵢ^{j}<=Qᵢ.
Where
Qᵢ^{j} is quantity of item i chosen by seller j
Qᵢ is the quantity of item i buyer wants to procure
iii. the server data processing machine accepts the bids and stores them in the database
iv. the optimization program residing in the server data processing machine processes the bids and calculates the winning bids based on the bid amount and additional information provided by buyer as recited in claim 6.d to find the winning bids
v. the winning bids claimed in 6.f.iv are calculated such that the buyer procures all items at the lowest cost
vi. the optimization program as claimed in 6.f.iv solves the following problem:
Minimize: P₁*Y₁+P₂*Y₂+ . . . Pₙ*Yₙ
Within constraints:
Q₁¹+Q₁²+Q₁³+ . . . +Q₁ⁿ>=Q₁
Q₂¹+Q₂²+Q₂³+ . . . +Q₂ⁿ>=Q₂
Qₘ¹+Qₘ²+Qₘ³+ . . . +Qₘⁿ>=Qₘ
Y₁ either 0 or 1
Y₂ either 0 or 1
Yₙ either 0 or 1
Where
Qᵢ is the quantity of item i in the lot
m is the number of different products classes in the lot
n is the number of bids
Pⱼ is the net cost to the buyer if seller j is selected as one of the winning bids. Pⱼ is the equal to the price quoted by seller j plus any additional cost that will be borne by the buyer for choosing seller j as the winning bidder
Qₘⁿ is the quantity of item m chosen by buyer n
vii. the method in 6.f.vi uses any of the following optimization techniques for optmization: linear programming, integer programming, domain reduction and constraint propagation, combinatorial optimization, genetic algorithms, simulated annealing or any other way for solving the problem that might be available
viii. the optimization program claimed in 6.f.vi solves for values of Yᵢ, i=1 to n
ix. if Yₙ is 1, then bid n is one of the winning bids.
x. step 6.f.iv is executed whenever a new bid is submitted
xi. step 6.f.i to 6.f.iv goes on till the time the bidding process ends at the time specified in 6.c
xii. after the expiration of time specified in 6.c, the bidding process ends and the winners are declared based on the last process run by step 6.f.iv
xiii. if the bidding process is an open-bid process, then winning bids are displayed continuously to the buyers during the bidding process else if the process is a sealed-bid process, then the winning bids are not displayed to the buyers until after the bidding ends and winner are declared

7. A method for buyers to buy multiple dissimilar products comprising steps of:
a. setting up a system as recited in claim 2
b. buyers set up items they wish to procure by accessing the server data processing machine from a client data processing machine through a computer network
c. buyer enters the items that he/she wishes to buy and enters the time the bidding process expires and type of auction
d. buyer specifies a reserve price (R) for the whole lot
e. buyer specifies additional information such as but not limited to shipping and handling, tax etc. or any other cost associated with the trade
f. buyer specifies whether it is an open-bid or a sealed-bid process
g. sellers bid for the items by accessing server data processing machine through the client data processing machines comprising steps of:
i. sellers pick and choose individual items or a group of items they wish to sell and bid for the items
ii. sellers pick any combination of items in any quantity—quantity chosen by seller j satisfies the following equation:
0<=Qᵢ^{j}<=Qᵢ.
Where
Qᵢ^{j} is quantity of item i chosen by seller j
Qᵢ is the quantity of item i buyer wants to procure
iii. the server data processing machine accepts the bids and stores them in the database
iv. the optimization program residing in the server data processing machine processes the bids and calculates the winning bids based on the bid amount and additional information provided by buyer as recited in claim 7.e to find the winning bids
v. the winning bids claimed in 7.g.iv are calculated such that the buyer procures all items at the lowest cost
vi. the optimization program as claimed in 7.g.iv solves the following problem:
Minimize: P₁*Y₁+P₂*Y₂+ . . . Pₙ*Yₙ
Within constraints:
Q₁¹+Q₁²+Q₁³+ . . . +Q₁ⁿ>=Q₁
Q₂¹+Q₂²+Q₂³+ . . . +Q₂ⁿ>=Q₂
Qₘ¹+Qₘ²+Qₘ³+ . . . +Qₘⁿ>Qₘ
Y₁ either 0 or 1
Y₂ either 0 or 1
Yₙ either 0 or 1
Where
Qᵢ is the quantity of item i in the lot
m is the number of different products classes in the lot
n is the number of bids
Pⱼ is the net cost to the buyer if seller j is selected as one of the winning bids. Pⱼ is the equal to the price quoted by seller j plus any additional cost that will be borne by the buyer for choosing seller j as the winning bidder
Qₘⁿ is the quantity of item m chosen by buyer n vii. the method in 7.g.vi uses any of the following optimization techniques for optmization: linear programming, integer programming, domain reduction and constraint propagation, combinatorial optimization, genetic algorithms, simulated annealing or any other way for solving the problem that might be available
viii. the optimization program claimed in 7.g.vi solves for values of Yᵢ, i=1 to n
ix. if Σ Pᵢ*Yᵢ for i=1 to n is less than or equal to reserve rice (R), and if Yₙ is 1, then bid n is one of the winning bids.
x. step 7.g.iv is executed whenever a new bid is submitted
xi. steps 7.g.i to 7.g.iv go on till the time the bidding process ends at the time specified in 7.c
xii. after the expiration of time specified in 7.c, the bidding process ends and the winners are declared based on the last process run by step 7.g.iv
xiii. if the bidding process is an open-bid process, then winning bids are displayed continuously to the buyers during the bidding process else if the process is a sealed-bid process, then the winning bids are not displayed to the buyers until after the bidding ends and winner are declared

8. A method for buyers to buy multiple dissimilar products comprising steps of:
a. setting up a system as recited in claim 2
b. buyers set up items they wish to procure by accessing the server data processing machine from a client data processing machine through a computer network comprising steps of:
c. buyer enters the items that he/she wishes to buy and enters the time the bidding process expires and type of auction
d. buyer specifies a reserve price Rᵢ for each unit of the item i in the lot. The buyer accepts bid from a seller only if bid amount Bⱼ of seller j is less than or equal to Σ Rᵢ*Qᵢ^{j}, i=1 to m, where Qᵢ^{j} is the quantity of item i chosen for bidding by seller j and m is the number of dissimilar items in the lot
e. buyer specifies additional information such as but not limited to shipping and handling, tax etc. or any other cost associated with the trade
f. buyer specifies whether it is an open-bid or a sealed-bid process
g. sellers bid for the items by accessing server data processing machine through the client data processing machines comprising steps of:
i. sellers pick and choose individual items or a group of items they wish to sell and bid for the items
ii. sellers pick any combination of items in any quantity—quantity chosen by seller j satisfies the following equation:
0<=Qᵢ^{j}<=Qᵢ.
Wherein
Qᵢ^{j} is quantity of item i chosen by seller j
Qᵢ is the quantity of item i buyer wants to procure
iii. the server data processing machine accepts the bids and stores them in the database
iv. the optimization program residing in the server data processing machine processes the bids and calculates the winning bids based on the bid amount and additional information provided by buyer as recited in claim 8.e to find the winning bids
v. the winning bids claimed in 8.g.iv are calculated such that the buyer procures all items at the lowest cost
vi. the optimization program as claimed in 8.g.iv solves the following problem:
Minimize: P₁*Y₁+P₂*Y₂+ . . . Pₙ*Yₙ
Within constraints:
Q₁¹+Q₁²+Q₁³+ . . . +Q₁ⁿ>=Q₁
Q₂¹+Q₂²+Q₂³+ . . . +Q₂ⁿ>=Q₂
•
•
Qₘ¹+Qₘ²+Qₘ³+ . . . +Qₘⁿ>=Qₘ
Y₁ either 0 or 1
Y₂ either 0 or 1
Yₙ either 0 or 1
Where
Qᵢ is the quantity of item i in the lot
m is the number of different products classes in the lot
n is the number of bids
Pⱼ is the net cost to the buyer if seller j is selected as one of the winning bids. Pⱼ is the equal to the price quoted by seller j plus any additional cost that will be borne by the buyer for choosing seller j as the winning bidder
Qₘⁿ is the quantity of item m chosen by buyer n
vii. the method in 8.g.vi uses any of the following optimization techniques for optmization: linear programming, integer programming, domain reduction and constraint propagation, combinatorial optimization, genetic algorithms, simulated annealing or any other way for solving the problem that might be available
viii. the optimization program claimed in 8.g.vi solves for values of Yᵢ, i=1 to n
ix. if Yₙ is 1, then bid n is one of the winning bids.
x. step 8.g.iv is executed whenever a new bid is submitted
xi. steps 8.g.i to 8.g.iv go on till the time the bidding process ends at the time specified in 8.c
xii. after the expiration of time specified in 8.c, the bidding process ends and the winners are declared based on the last process run by step 8.g.iv
xiii. if the bidding process is an open-bid process, then winning bids are displayed continuously to the buyers during the bidding process else if the process is a sealed-bid process, then the winning bids are not displayed to the buyers until after the bidding ends and winner are declared

9. A method for buyers to buy multiple dissimilar products comprising steps of:
a. setting up a system as recited in claim 2
b. buyers set up items they wish to procure by accessing the server data processing machine from a client data processing machine through a computer network comprising steps of:
c. buyer enters the items that he/she wishes to buy and enters the time the bidding process expires and type of auction
d. buyer specifies additional information such as but not limited to shipping and handling, tax etc. or any other cost associated with the trade
e. buyer specifies whether it is an open-bid or a sealed-bid process
f. sellers bid for the items by accessing server data processing machine through the client data processing machines comprising steps of:
i. sellers pick and choose individual items or a group of items they wish to sell and bid for the items
ii. sellers pick any combination of items in any quantity—quantity chosen by seller j satisfies the following equation:
0<=Qᵢ^{j}<=Qᵢ.
Where
Qᵢ^{j} is quantity of item i chosen by seller j
Qᵢ is the quantity of item i buyer wants to procure
iii. the server data processing machine accepts the bids and stores them in the database
iv. the optimization program residing in the server data processing machine processes the bids and calculates the winning bids based on the bid amount and additional information provided by buyer as recited in claim 9.d to find the winning bids
v. the winning bids claimed in 9.f.iv are calculated such that the buyer procures all items at the lowest cost
vi. the optimization program as claimed in 9.f.iv solves the following problem:
Minimize: P₁*Y₁+P₂*Y₂+ . . . Pₙ*Yₙ
Within constraints:
Q₁¹+Q₁²+Q₁³+ . . . +Qₘⁿ=Q₁
Q₂¹+Q₂²+Q₂³+ . . . +Q₂ⁿ=Q₂
Qₘ¹+Qₘ²+Qₘ³+ . . . +Qₘⁿ=Qₘ
Y₁ either 0 or 1
Y₂ either 0 or 1
Yₙ either 0 or 1
Where
Qᵢ is the quantity of item i in the lot
m is the number of different products classes in the lot
n is the number of bids
Pⱼ is the net cost to the buyer if seller j is selected as one of the winning bids. Pⱼ is the equal to the price quoted by seller j plus any additional cost that will be borne by the buyer for choosing seller j as the winning bidder
Qₘⁿ is the quantity of item m chosen by buyer n
vii. the method in 9.fvi uses any of the following optimization techniques for optmization: linear programming, integer programming, domain reduction and constraint propagation, combinatorial optimization, genetic algorithms, simulated annealing or any other way for solving the problem that might be available
viii. the optimization program claimed in 9.f.vi solves for values of Yᵢ, i=1 to n
ix. If Yₙ is 1, then bid n is one of the winning bids.
x. step 9.f.iv is executed whenever a new bid is submitted
xi. steps 9.f.i to 9.f.iv go on till the time the bidding process ends at the time specified in 9.c
xii. after the expiration of time specified in 9.c, the bidding process ends and the winners are declared based on the last process run by step 9.f.iv
xiii. if the bidding process is an open-bid process, then winning bids are displayed continuously to the buyers during the bidding process else if the process is a sealed-bid process, then the winning bids are not displayed to the buyers until after the bidding ends and winner are declared

10. A method for buyers to buy multiple dissimilar products comprising steps of:
a. setting up a system as recited in claim 2
b. buyers set up items they wish to procure by accessing the server data processing machine from a client data processing machine through a computer network comprising steps of:
c. buyer enters the items that he/she wishes to buy and enters the time the bidding process expires and type of auction
d. buyer specifies a reserve price (R) for the whole lot
e. buyer specifies additional information such as but not limited to shipping and handling, tax etc. or any other cost associated with the trade
f. buyer specifies whether it is an open-bid or a sealed-bid process
g. sellers bid for the items by accessing server data processing machine through the client data processing machines comprising steps of:
i. sellers pick and choose individual items or a group of items they wish to sell and bid for the items
ii. sellers pick any combination of items in any quantity—quantity chosen by seller j satisfies the following equation:
0<=Qᵢ^{j}<=Qᵢ.
Where
Qᵢ^{j} is quantity of item i chosen by seller j
Qᵢ is the quantity of item i buyer wants to procure
iii. the server data processing machine accepts the bids and stores them in the database
iv. the optimization program residing in the server data processing machine processes the bids and calculates the winning bids based on the bid amount and additional information provided by buyer as recited in claim 10.e to find the winning bids
v. the winning bids claimed in 10.g.iv are calculated such that the buyer procures all items at the lowest cost
vi. the optimization program as claimed in 10.g.iv solves the following problem:
Minimize: P₁*Y₁+P₂*Y₂+ . . . Pₙ*Yₙ
Within constraints:
Q₁¹+Q₁²+Q₁³+ . . . +Q₁ⁿ=Q₁
Q₂¹+Q₂²+Q₂³+ . . . +Q₂ⁿ=Q₂
Qₘ¹+Qₘ²+Qₘ³+ . . . +Qₘⁿ=Qₘ
Y₁ either 0 or 1
Y₂ either 0 or 1
Yₙ either 0 or 1
Where
Qᵢ is the quantity of item i in the lot
m is the number of different products classes in the lot
n is the number of bids
Pⱼ is the net cost to the buyer if seller j is selected as one of the winning bids. Pⱼ is the equal to the price quoted by seller j plus any additional cost that will be borne by the buyer for choosing seller j as the winning bidder
Qₘⁿ is the quantity of item m chosen by buyer n
vii. the method in 10.g.vi uses any of the following optimization techniques for optmization: linear programming, integer programming, domain reduction and constraint propagation, combinatorial optimization, genetic algorithms, simulated annealing or any other way for solving the problem that might be available
viii. the optimization program claimed in 10.g.vi solves for values of Yᵢ, i=1 to n
ix. if Σ Pᵢ*Yᵢ for i=1 to n is less than or equal to reserve rice (R), and if Yₙ is 1, then bid n is one of the winning bids.
x. step 10.g.iv is executed whenever a new bid is submitted
xi. steps 10.g.i to 10.g.iv go on till the time the bidding process ends at the time specified in 10.c
xii. after the expiration of time specified in 10.c, the bidding process ends and the winners are declared based on the last process run by step 10.g.iv
xiii. if the bidding process is an open-bid process, then winning bids are displayed continuously to the buyers during the bidding process else if the process is a sealed-bid process, then the winning bids are not displayed to the buyers until after the bidding ends and winner are declared

11. A method for buyers to buy multiple dissimilar products comprising steps of:
a. setting up a system as recited in claim 2
b. buyers set up items they wish to procure by accessing the server data processing machine from a client data processing machine through a computer network comprising steps of:
c. buyer enters the items that he/she wishes to buy and enters the time the bidding process expires and type of auction
d. buyer specifies a reserve price Rᵢ for each unit of the item i in the lot. The buyer accepts bid from a seller only if bid amount Bⱼ of seller j is less than or equal to Σ Rᵢ*Qᵢ, i=1 to m, where Qᵢ^{j} is the quantity of item i chosen for bidding by seller j and m is the number of dissimilar items in the lot
e. buyer specifies additional information such as but not limited to shipping and handling, tax etc. or any other cost associated with the trade
f. buyer specifies whether it is an open-bid or a sealed-bid process
g. sellers bid for the items by accessing server data processing machine through the client data processing machines comprising steps of:
i. sellers pick and choose individual items or a group of items they wish to sell and bid for the items
ii. sellers pick any combination of items in any quantity—quantity chosen by seller j satisfies the following equation:
0<=Qᵢ^{j}<=Qᵢ.
Where
Qᵢ^{j} is quantity of item i chosen by seller j
Qᵢ is the quantity of item i buyer wants to procure
iii. the server data processing machine accepts the bids and stores them in the database
iv. the optimization program residing in the server data processing machine processes the bids and calculates the winning bids based on the bid amount and additional information provided by buyer as recited in claim 11.e to find the winning bids
v. the winning bids claimed in 11.g.iv are calculated such that the buyer procures all items at the lowest cost
vi. the optimization program as claimed in 11.d.iv solves the following problem:
Minimize: P₁*Y₁+P₂*Y₂+ . . . Pₙ*Yₙ
Within constraints:
Q₁¹+Q₁²+Q₁³+ . . . +Q₁ⁿ=Q₁
Q₂¹+Q₂²+Q₂³+ . . . +Q₂ⁿ=Q₂
Qₘ¹+Qₘ²+Qₘ³+ . . . +Qₘⁿ=Qₘ
Y₁ either 0 or 1
Y₂ either 0 or 1
Yₙ either 0 or 1
Where
Qᵢ is the quantity of item i in the lot
m is the number of different products classes in the lot
n is the number of bids
Pⱼ is the net cost to the buyer if seller j is selected as one of the winning bids. Pⱼ is the equal to the price quoted by seller j plus any additional cost that will be borne by the buyer for choosing seller j as the winning bidder
Qₘⁿ is the quantity of item m chosen by buyer n
vii. the method in 11.g.vi uses any of the following optimization techniques for optmization: linear programming, integer programming, domain reduction and constraint propagation, combinatorial optimization, genetic algorithms, simulated annealing or any other way for solving the problem that might be available
viii. the optimization program claimed in 11.g.vi solves for values of Yᵢ, i=1 to n
ix. if Yₙ is 1, then bid n is one of the winning bids.
x. step 11.g.iv is executed whenever a new bid is submitted
xi. steps 11.g.i to 11.g.iv go on till the time the bidding process ends at the time specified in 11.c
xii. after the expiration of time specified in 11.c, the bidding process ends and the winners are declared based on the last process run by step 11.g.iv
xiii. if the bidding process is an open-bid process, then winning bids are displayed continuously to the buyers during the bidding process else if the process is a sealed-bid process, then the winning bids are not displayed to the buyers until after the bidding ends and winner are declared
Invention's Application
The described mechanism can be easily implemented though a system of computer networks.
The previously mentioned needs are addressed by the present invention, in which market participants will be able to exchange among themselves, a combination of products as a bundle. The present invention can be applied to set up an online digital marketplace or exchange system addressing the above-mentioned needs. This online system can be easily developed through a set of computers connected through a network. This system of computer network executing a trade matching mechanism provides the function of a market intermediary, recombining products from different market participants such that the requirements of participants seeking to acquire a particular combination of products are satisfied by participants seeking to dispose of the same products. The invention provides a mechanism for exchange of multiple products between two or more market participants. An online digital marketplace for the exchange of goods as mentioned in this invention can be implemented using a set of computers connected through a network.
This computer network could be in any form like a private network or a public network like Internet or World Wide Web.
The invention mentioned here can be used for a variety of exchange mechanisms. One of them is auction. The auction can be used for either disposing of products or for acquiring products. An online mechanism where businesses can post their products for sale or post their Request for Quotes or Request for Proposal or tenders. This online exchange will deal with disposing or acquisition of multiple products and help business efficiently trade goods as mentioned in the invention.
Throughout this document, the terms “objects”, “items”, and “units” are used essentially interchangeably. The inventive system may be used both for tangible objects, such as real or personal property, and intangible objects, such as telecommunications licenses or electric power or services. The inventive system may be used for trading where the business entity is a seller, buyer or broker, the users are buyers, sellers or brokers, and for trading-like activities which cannot be interpreted as selling or buying. The inventive system may be used for items including, but not restricted to, the following: public-sector bonds, bills, notes, stocks, and other securities or derivatives; private-sector bonds, bills, notes, stocks, and other securities or derivatives; communication licenses and spectrum rights; electric power and other commodity items; airport landing slots; emission allowances and pollution permits; and other objects, items or property, tangible or intangible.
It should be emphasized that whenever this document refers to “multiple dissimilar” objects, the terminology should be interpreted as meaning that the mechanism is capable of effecting the auctioning of multiple dissimilar objects. However, there is no requirement that the objects auctioned be multiple or dissimilar, and the mechanism and its implementation can also be used for exchange of identical or similar objects. By the same token, whenever the document refers to “multiple identical” objects, the terminology should be interpreted as referring to a context where bidders primarily are concerned with the quantity of items they receive, as opposed to the identity of the individual objects they receive. As such, “identical” objects can also be used for “close substitutes” or for a single object.
In here, the term cost means any cost such as tangible, intangible, quantifiable or perceived cost. The cost could include such costs as shipping and handling, tax, quality cost, reliability of delivery etc. or any cost the buyer or seller sees fit to add to that particular trade.
Although various advantages and applications of the present invention have been described herein in detail, it will be appreciated by those skilled in the art, that variations may be made thereto without departing from the spirit and scope of the invention.
